(19) United States
(12) Patent Application Publication
(10) Pub. No.: US 2005/0025904 A1
(43) Pub. Date: Feb. 3, 2005

(54) Method of forming a decorative motif on a component of lighting or indicating apparatus for a motor vehicle

(76) Inventor: Thomas Giroud, Paris (FR)

Correspondence Address: MORGAN & FINNEGAN, L.L.P., 3 WORLD FINANCIAL CENTER, NEW YORK, NY, 10281-2101, US

(21) Appl. No.: 10/729,305

(22) Filed: Dec. 4, 2003

(30) Foreign Application Priority Data
Dec. 5, 2002 (FR) 02 15 674

(51) Int. Cl. B05D 3/00; B32B 3/00; B32B 15/08

(52) U.S. Cl. 427/532; 428/209

(57) ABSTRACT

The present invention relates to a method of making a decorative motif on a component of a lighting or indicating apparatus for a motor vehicle. The method is adapted more particularly to making the mask for a headlight or indicator light. The method includes a step of forming the said component in a predetermined material, and a step of exposing at least one surface of the said component to laser radiation.

### FIELD OF THE INVENTION

The present invention relates to a method of forming a decorative motif or pattern on a component of a lighting or indicating apparatus for a motor vehicle. This method is more particularly adapted to forming motifs on masks or bodies for headlights or indicator lights.

### BACKGROUND OF THE INVENTION

Motor manufacturers very often require there to be particular motifs or patterns on lighting or indicating devices. These motifs, which are precise and indelible, and are formed on certain components such as the mask of the headlight or the body of the indicating light, are most usually provided for aesthetic purposes only.

Such motifs or patterns are obtained, in a first method, by marking the mould in which the components are made, but this leads to lack of flexibility and a tendency to induce wear in the mould. The mould can easily become worn, or be contaminated by impurities.

A second method consists in deposition of inks (screen process printing) on the component which is to be decorated. This method gives rise to problems of fastness of the ink over the life of the component, and also raises questions as to its resistance to ultraviolet rays.

A third method consists in making the motifs by using paint with masking or selective application systems. However, a method of this kind does not enable very precise limits to be obtained, because the paint infiltrates between the component being decorated and the mask.

A fourth method consists in adding inserts, such as decorative films of the so-called in-mould decoration type (IMD). This kind of method is expensive, and gives rise to problems connected with thermoforming of the film.

### DISCUSSION OF THE INVENTION

The present invention aims to provide a method for making a decorative motif on a component of a lighting or indicating apparatus for a motor vehicle, which enables accurate motifs to be formed at low cost on components such as masks or bodies or base members, without making use of a mould with any particular kind of marking, and without using paint or marking ink or inserts such as films.

To this end, the present invention proposes a method of forming a decorative motif on a lighting or indicating apparatus for a motor vehicle which comprises a step of forming the said component itself in a predetermined material.

According to the invention, the said method includes a step of exposing at least one surface of the said component to laser radiation.

In this specification, the term “component” means an element of a lighting or indicating apparatus which plays no part in the formation of the light beam emitted outwards from the apparatus, examples being a mask or a body or base member of a lighting or indicating (signalling) apparatus.

Thus, we start with a component which is formed, for example by moulding, in a material, such as a plastics material, which may or may not be metallised. Laser technology then either enables selective removal of the metal coating to be performed on the said component where the latter is metallised, or enables the component to be exposed directly on the plastics material.

Removal of a particular metallic surface does not affect the plastics material, and therefore allows a zone of plastics material to appear. This zone corresponds to a particular decorative motif. If the plastics material is coloured, the motif which is revealed is itself in that colour.

Exposure of the laser directly on the plastics material enables the colour of the plastics material to be modified. In this way, a motif is obtained directly on the plastics material, with a colour which is determined according to the parameters of the laser radiation.

Such a method accordingly makes it possible to start with an unmarked component, and offers wide flexibility of use in order to make any types of motifs. The method involves neither adaptation of the mask nor any insert or marking material.

Preferably, a plurality of surfaces of the said component are exposed to the said laser radiation.

Thus it is possible to create a plurality of motifs on the component. The motifs may be of identical form, or different from each other.

In a first embodiment, the method includes a step of completely metallising the said component before the said step of exposing it to laser radiation, the said exposure step being a step of selective removal, by laser radiation, of the metal on at least one surface of the said metallised component.

In a second embodiment, the said predetermined material is a plastics material, and the said step of exposing it to laser radiation is such that the colour of the said surface is modified with respect to the colour of the said plastics material.

Preferably, the laser radiation is performed by means of a YAG laser, a CO₂ laser, or a machining laser.

The present invention is also directed to a component for a lighting or indicating apparatus for a motor vehicle obtained by the method of the invention, the said component being of a predetermined material and having at least one surface which is obtained after exposure to laser radiation.

The present invention is further directed to a component of a lighting or indicating apparatus for a motor vehicle obtained by the method of the invention in which the said component is of plastics material and has a metallised surface and a non-metallised surface which is obtained after selective removal of the metal by laser radiation.

The said plastics material is preferably coloured.

Preferably, the said plastics material is a thermoplastic material.

The said component preferably has a plurality of surfaces obtained after exposure to laser radiation.

Thus it is possible to obtain a plurality of decorative motifs on the component.

Further features and advantages of the present invention will appear in the following description of embodiments of the invention, which is given by way of illustration and is in no way limiting.

### BRIEF DESCRIPTION OF THE DRAWING

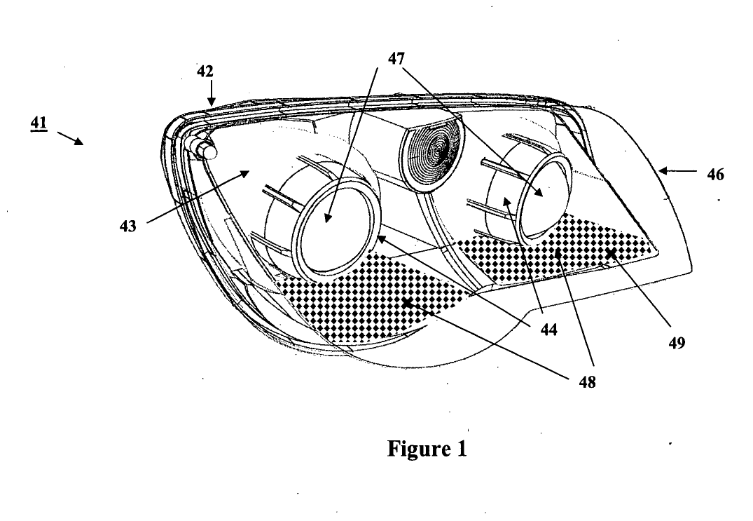

In the single FIGURE of the drawing, FIG. 1 is a diagrammatic illustration of a headlight which includes a mask that has decorative motifs made by the method of the invention.

### DESCRIPTION OF A PREFERRED EMBODIMENT

FIG. 1 shows diagrammatically a headlight 41 which includes a mask having decorative motifs obtained by the method of the invention.

In particular, the headlight 41 comprises:
a housing 42,
a protective front glass 46,
elliptical headlight lenses 47, and
a mask 43.

The three elements consisting of the housing 42, protective glass 46 and mask 43 are injection moulded in thermoplastic material.

The mask 43 has two openings 44 for the elliptical headlight lenses 47.

The mask 43 includes two surfaces 48, and each of these two surfaces 48 comprises a plurality of black lozenges 49.

The mask 43 is injection moulded in black-body coloured thermoplastic material.

The mask 43 is then metallised with an aluminium layer completely covering it.

Selective removal of the aluminium layer is then carried out in such a way as to reveal the black lozenges 49.

This method accordingly enables a mask to be made at low cost with decorative motifs or logos.

The invention is of course not limited to the embodiments just described.

In particular, the materials described, subjected to laser radiation, were plastics and aluminium, but they might be other materials, such as other metals.

In addition, the invention has been described only in the case of a headlight mask, but it can equally well be applied to other devices used for lighting or signalling purposes in the automotive field, such as rear light elements.

1. A method of forming a decorative motif on a component of a lighting or indicating apparatus for a motor vehicle, including a step of forming the said component in a predetermined material, wherein the said method includes a step of exposing at least one surface of the said component to laser radiation.

2. A method according to claim 1, wherein a plurality of surfaces of the said component are exposed to the said laser radiation.

3. A method according to claim 1 including a step of completely metallising the said component before the said step of exposing it to laser radiation, the said exposure step being a step of selective removal, by laser radiation, of the metal on at least one surface of the said metallised component.

4. A method according to claim 1, wherein the said predetermined material is a plastics material and the said step of exposing it to laser radiation is such that the colour of the said surface is modified with respect to the colour of the said plastics material.

5. A method according to claim 1, wherein the step of exposure to laser radiation is performed by means of a laser selected from the group consisting of a YAG laser, a CO₂ laser, or a machining laser.

6. A component for a lighting or indicating apparatus for a motor vehicle obtained by a method according to claim 1, the said component being of a predetermined material and having at least one surface which is obtained after exposure to laser radiation.

7. A component obtained by the method of claim 3, the said component being of plastics material and having a metallised surface and a non-metallised surface which is obtained after selective removal of the metal by laser radiation.

8. A component according to claim 7, wherein the said plastics material is coloured.

9. A component according to claim 7, wherein the said plastics material is a thermoplastic material.

10. A component according to claim 6, having a plurality of surfaces obtained after exposure to laser radiation.
